(19) United States
(12) Patent Application Publication
(10) Pub. No.: US 2003/0202123 A1
(43) Pub. Date: Oct. 30, 2003

(54) Synchronous signal superimposing apparatus and synchronous signal superimposing method, which use constant current source

(76) Inventors: Kazuo Ota, Yokohama-shi (JP); Takuya Yamauchi, Tokyo (JP)

Correspondence Address: LOUIS WOO, LAW OFFICE OF LOUIS WOO, 717 NORTH FAYETTE STREET, ALEXANDRIA, VA, 22314, US

(21) Appl. No.: 10/421,838

(22) Filed: Apr. 24, 2003

(30) Foreign Application Priority Data
Apr. 26, 2002 (JP) 2002-127673

(51) Int. Cl. H04N 5/268

(52) U.S. Cl. 348/705; 348/262

(57) ABSTRACT

A synchronous signal superimposing apparatus and a synchronous signal superimposing method are disclosed which do not require a high power supply voltage, and do not bring about the deterioration in the frequency property of a termination system caused by frequency properties of a coupling capacitor and a driver, and do not require the mechanism for changing the setting of a termination circuit through a switching operation and the like, correspondingly to a camera side. In this apparatus, a constant current driver for responding to an external synchronous signal and a capacitor for stopping a direct current component in an output signal from this constant current driver are placed correspondingly to each of a plurality of cables connected to image pickup units.

### BACKGROUND OF THE INVENTION

1. Field of the Invention

The present invention relates to an apparatus for and a method of superimposing a predetermined synchronous signal in order to synchronize image signals from a plurality of image pickup units, such as cameras and the like, which are connected through cables. More particularly, the present invention relates to an apparatus and a method suitable for a system that uses a plurality of monitor cameras.

2. Description of the Related Art

The main purpose of a monitor TV system that carries out a synchronous operation for a plurality of image signal sources is to avoid the rolling phenomenon of a display monitor (a flow in a vertical direction of an image when an image signal is switched because of a step-out). However, as one of devices for carrying out the synchronization, there is a case of using a positive pulse superimposed on a vertical synchronous signal in the image signal. On the side of a camera, in time to match the timing of this pulse, the generation of the synchronous signal in the image signal is locked by PLL to thereby result in the attainment of the synchronous operation between the superimposed external synchronous pulse and the image signal. This method sends the standard superimposed external pulse to the respective camera sides. In synchronization with this, a vertical phase of the image signal from the camera side is coincident. Thus, it can be said that this method is the excellent method which enables the system of the synchronous operation to be established without any adjustment.

FIG. 4 is a circuit diagram showing the conventional above-mentioned synchronous signal superimposing apparatus. According to a conventional constant voltage method, when a function of superimposing a synchronous signal is used in a system, it is designed so as to connect an image signal from a camera (not shown) to this superimposing unit 10 and carry out a termination. That is, the superimposing unit 10 includes: a termination resistor 11 connected to an image input terminal 16; a driving amplifier 12 that can send out this resistance component at a small impedance at the degree that it can be sufficiently ignored; and a capacitor 18 for coupling the termination resistor 11 to the driving amplifier 12 in an alternating current manner. By the way, the termination resistor 11, the driving amplifier 12 and the capacitor 18 constitute the termination circuit coupled in the alternating current manner.

It is necessary that the frequency properties of the driving amplifier 12 and the capacitor 18 constituting this termination circuit have the small impedances not only for a driven pulse but also for the entire signal band from the camera as the termination impedance receiving the signal of the camera. By the way, in order to carry out the synchronous superimposition through a constant voltage source, the driving amplifier 12 needs to receive a signal equal to two times the amplitude of the superimposition pulse, from a synchronous pulse generator 20. Similarly, in order to send the image signal to an image output terminal 17 connected to a switcher side (not shown), together with a +6 dB driver 14 for compensating for a loss of 6 dB caused by a transmission termination resistor 13, it is sent to the switcher side. Moreover, by considering the case when this superimposing function is not used or when the power supply of this circuit block is turned off, a bypass switch (SW) 15 such as a relay and the like is mounted. At this time, a contact is closed.

As evident from the above-mentioned explanations, the conventional apparatus and method use the voltage source as the actual circuit means for superimposing the synchronous signal on the image signal. That is, it depends on the drive of the superimposition pulse through the voltage source. However, it is necessary to attain the superimposing operation while carrying out the termination of the image signal circuit. Thus, the alternating termination circuit, which has the driver of the small impedance and uses both of the transmission impedance and the reception impedance as the termination impedance, requires the power supply voltage at which the voltage equal to or higher than two times the superimposition pulse voltage can be outputted. Also, the termination in the alternating current manner brings about the deterioration in the frequency property of the termination system caused by the frequency properties of the coupling capacitor and the driver. Moreover, the circuit type requiring the direct current termination where the transmitting circuit on the camera side must be terminated directly through the resistor to the termination circuit requires the mechanism for changing the setting of this termination circuit through a switching operation and the like, correspondingly to the camera side.

### SUMMARY OF THE INVENTION

It is therefore an object of the present invention is to provide a synchronous signal superimposing apparatus and a synchronous signal superimposing method, which solve the problems in the above-mentioned conventional apparatus and method, and do not require the high power supply voltage, and do not bring about the deterioration in the frequency property of the termination system caused by the frequency properties of the coupling capacitor and the driver, and do not require the mechanism for changing the setting of the termination circuit through the switching operation and the like, correspondingly to the camera side.

In order to solve the above-mentioned object, in the present invention, a constant current driver for responding to an external synchronous signal and a capacitor for stopping a direct current component of an output signal from this constant current driver are placed correspondingly to each of a plurality of cables serving as transmission paths connected to image pickup units.

That is, according to the present invention, this provides a synchronous signal superimposing apparatus, which when switching between image signals generated by a plurality of image pickup units and selectively sending the image signal to at least one monitor, sends an external synchronous signal to each of a plurality of cables through which the image signal is transmitted from each of the image pickup units, and thereby superimposes the external synchronous signal on the image signal, further including:

a plurality of cables each transmitting the image signals from the plurality of image pickup units;

constant current drivers for responding to the external synchronous signal, in which the number of the constant current drivers is equal to the number of the plurality of cables; and

capacitors, each of which is inserted between each of output terminals of the constant current drivers and each of the plurality of cables, for stopping direct current components in output signals from said respective constant current drivers.

Also, according to the present invention, this provides a synchronous signal superimposing method, which when switching between image signals generated by a plurality of image pickup units and selectively sending the image signal to at least one monitor, sends an external synchronous signal to each of a plurality of cables through which the image signal is transmitted from each of the image pickup units, and thereby superimposes the external synchronous signal on the image signal, further including the steps of:

generating a plurality of constant currents through a plurality of constant current drivers which respond to the external synchronous signal; and

stopping a direct current component included in each of the constant currents, sending to each of the plurality of cables, and then superimposing on the image signal.

According to this configuration, the portion for superimposing the external synchronous signal to be coupled through the current source, namely, the high impedance has the action of carrying out the external synchronization which enables the superimposition through the connection even from any position between the termination units on the transmission path. Thus, this configuration has an advantageous effect that the synchronizing system can be established through the easy interface such as the branch connection to the cable, in order to attain this function.

Also, in the present invention, as for the superimposition of the external synchronous signal, the superimposition can be attained by installing and placing as the unit having no termination between the transmission paths without performing any modification and change on other units which do not have this function. Thus, when the synchronous operation is carried out by applying the present invention to the existing monitor system that does not use the synchronizing system and if the camera side can cope with the superimposed external synchronous pulse, the superimposing unit can establish the connection and the disconnection of the termination circuit. Hence, this method has the action for enabling the function of the synchronous operation to be added without any modification and addition to the conventional system unit.

Also, in the present invention, since the superimposition of the external synchronous pulse is carried out by the constant current drive, the power supply voltage of the driving system can be dropped over the constant voltage drive. Thus, as the actual circuit merit, since the superimposition principle based on the conventional constant voltage has the voltage division action resulting from the termination resistor, the generation of the superimposition pulse having a relatively high amplitude necessary for the external synchronous pulse requires the power supply voltage, which enables the output of the element equal to or greater than approximately two times the amplitude, as the circuit voltage. Hence, it is difficult to freely set the power supply voltage as the unit. However, if the current can be generated when the constant current drive is used, this method has the merit that it can be set at a relatively low voltage.

Also, in the present invention, the superimposition of the external synchronous pulse is carried out by the constant current drive. Thus, the employment of the configuration in which the image signal is directly terminated at the resistor can keep the termination impedance for the frequency property of the image signal stable to thereby protect the image to be deteriorated. Hence, the resistor is directly used at the termination. Consequently, this has the action that it is terminated in the very ideal matching without any frequency deterioration which results in the problem when the capacitor and the low output impedance driver are used.

Also, in the present invention, the superimposition of the external synchronous pulse is carried out by the constant current drive. Thus, the employment of the configuration, in which the image signal is directly terminated at the resistor, does not require the switching operation when the resistor is directly required at the termination of the image signal. Thus, the input interface of the unit can be made easier. In the case of the conventional constant voltage drive, it can not be directly terminated at the resistor. Thus, this method can not be used when the configuration of the output circuit of the camera or a part of the image unit requires the direct resistor termination after the transmission. Hence, after the modification to the circuit based on the resistor termination method, the image must be inevitably inputted. However, the present invention has the action that even the camera and the image unit having the above-mentioned circuit configuration can be connected without any switching setting and without any problem, since the current source superimposition is performed on the transmission line directly terminated at the resistor.

Also, in the present invention, the superimposition of the external synchronous pulse is carried out by the constant current drive. Thus, the employment of the configuration, in which the image signal is directly terminated at the resistor, enables the termination to be always reserved whether the power supply of the termination unit is turned on or off, and does not require the loop-through switching of the signal in the voltage source driving method, and can thereby make the input interface of the unit easier. In the case of the conventional constant voltage drive, it can not be directly terminated at the resistor. Thus, the device for directly sending the signal through a relay and the like even if the power supply is turned off is required when the power supply of the unit placed in the middle of the transmission path is turned off. However, the present invention is designed such that the current source is superimposed on the transmission line directly terminated at the resistor, and the input terminal and the output terminal of the unit are same. Hence, the present invention has the action that the connection can be established in which the switching setting and the dedicated loop-through circuit are not required without any problem.

### BRIEF DESCRIPTION OF THE DRAWINGS

FIG. 1 is a basic system configuration view in a preferable embodiment of the present invention;

FIG. 2 is a circuit diagram showing a part of a configuration of a pulse superimposing unit in FIG. 1 and the like;

FIG. 3 is a signal waveform view showing an operation in a preferable embodiment of the present invention; and

FIG. 4 is a circuit diagram showing a conventional synchronous signal superimposing method.

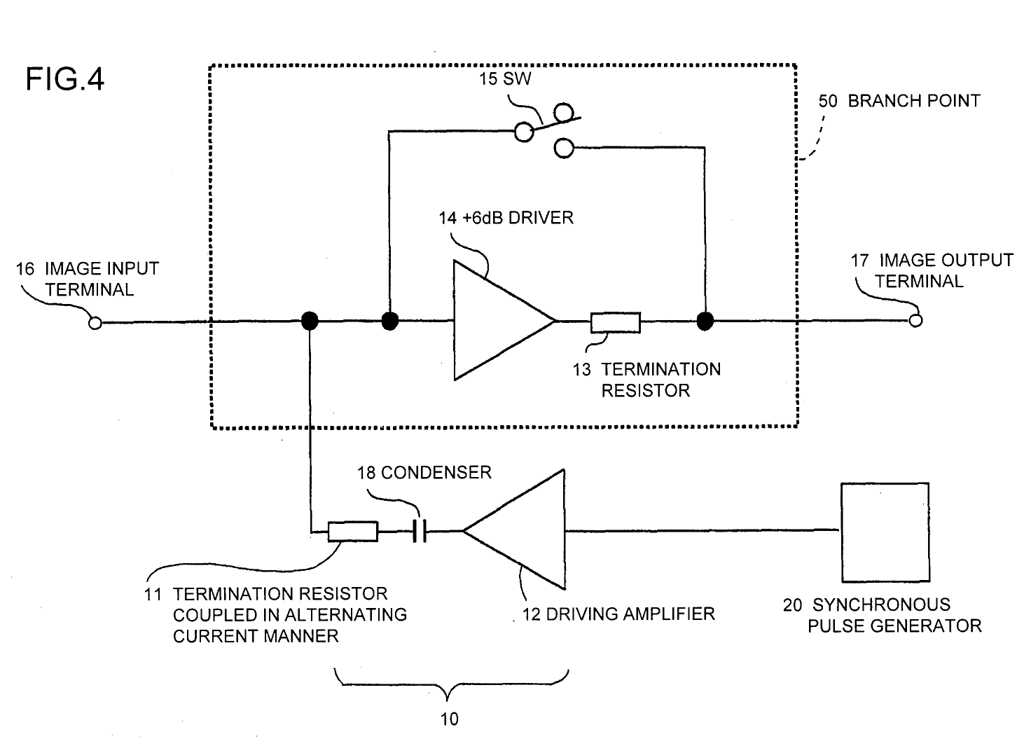

### DETAILED DESCRIPTION OF THE PREFERRED EMBODIMENT

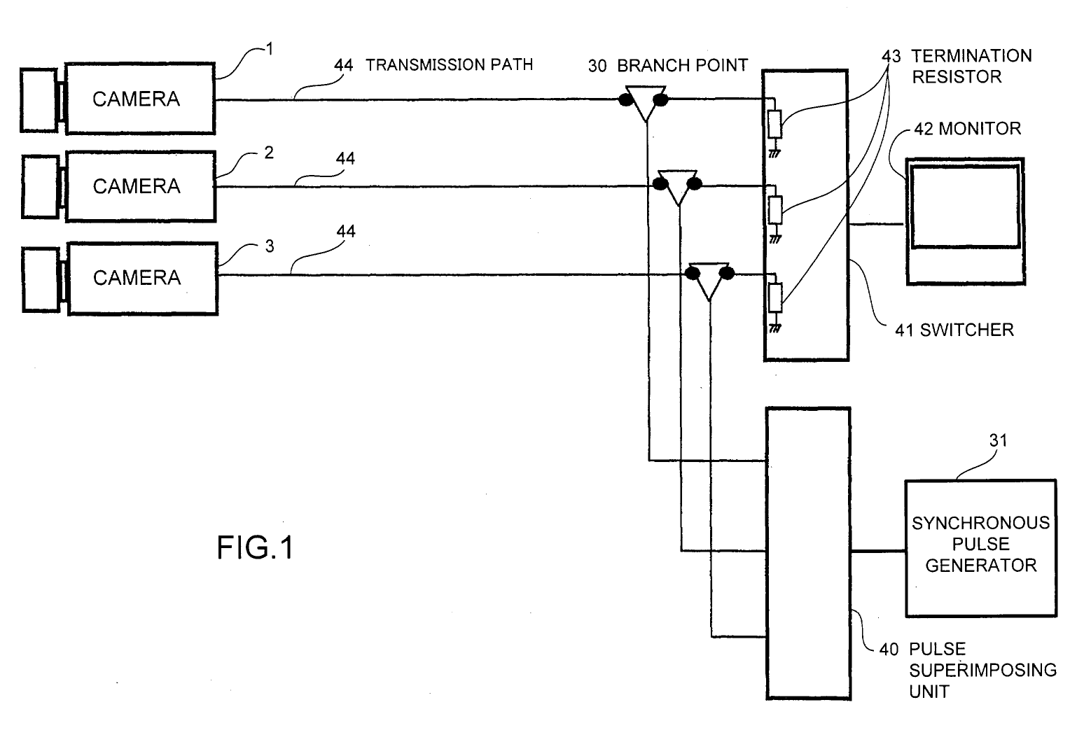

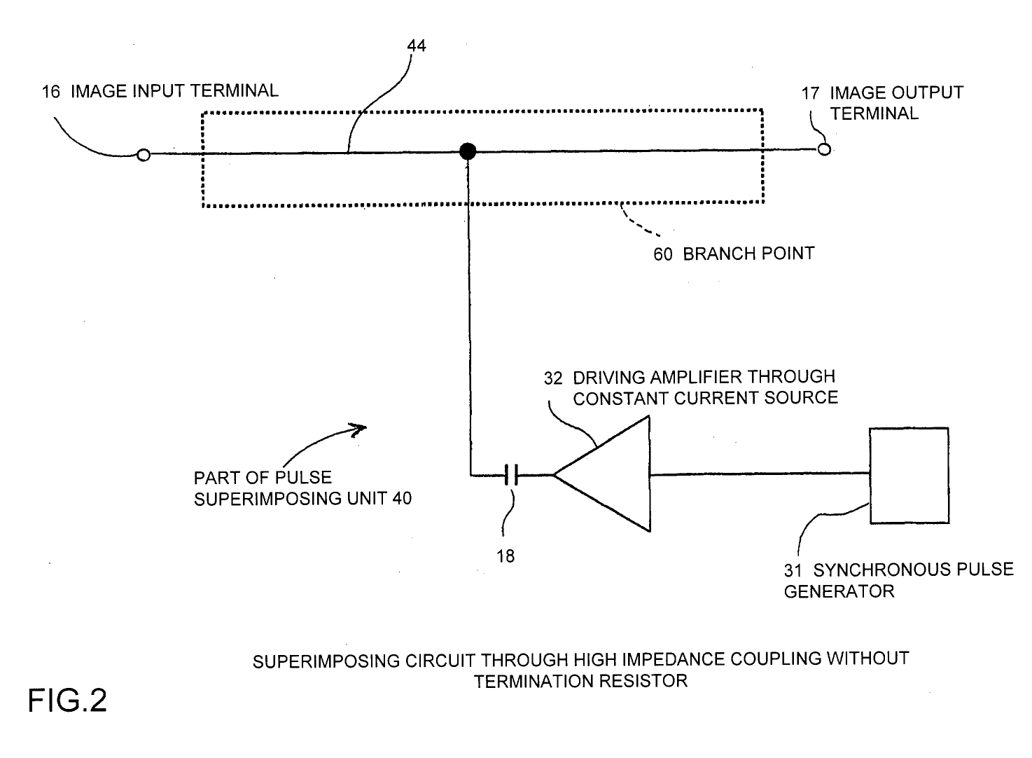

An embodiment according to the present invention will be described below with reference to the attached drawings. FIG. 1 is an entire configuration view of the preferable embodiment when a synchronous signal superimposing apparatus and a synchronous signal superimposing method of the present invention are applied to a monitor TV camera system, and FIG. 2 is a view showing the relation between a part of a configuration of a pulse superimposing unit 40 in FIG. 1 and a part of transmission paths 44. This monitor TV camera system uses an external synchronizing method of superimposing a synchronous pulse as a synchronous signal given from an external portion on a vertical fly-back period of an image signal.

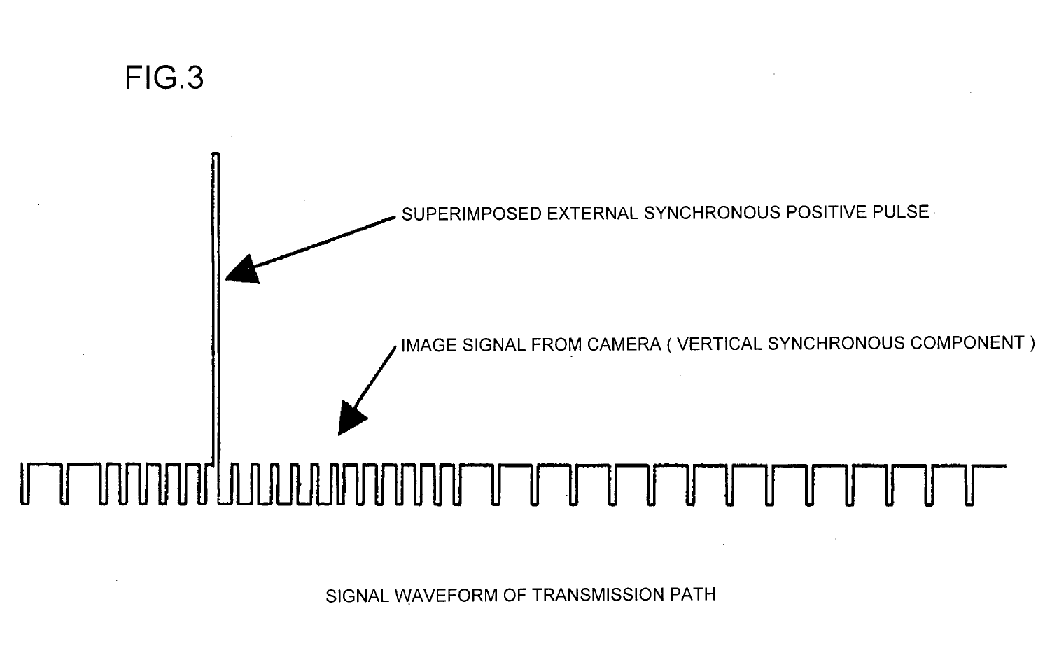

In the embodiment of FIG. 1, the image signals representing respective images picked up by three cameras 1, 2 and 3 synchronous with one another are sent through the three transmission paths (cables) 44 to a switcher 41, and a desirable image signal is selected by the switcher 41. Then, the desirable image picked up by the camera is displayed on a monitor 42. Here, the synchronizing function for avoiding the scrolling of the image caused by the switching in the switcher 41 and the like is attained by sending, to the respective transmission paths 44, the synchronous pulse as the synchronous signal generated by the pulse superimposing unit 40, which is a different unit from the switcher 41 for attaining the selecting function. The matching termination at both ends of the transmission path 44 is carried out by a typical method that is frequently used at a termination portion from which the camera is fed out and an input end of the switcher 41. Even in the case of the connection of the pulse superimposing unit 40, due to the high impedance, this has no influence on the transmission path 44, except the superimposing action. FIG. 3 shows a waveform example of the signal on the transmission path in the condition that the external synchronous pulse is superimposed on the image signal to thereby attain the synchronous operation.

The actual configuration example of the pulse superimposing unit 40 will be described below with reference to FIG. 2. FIG. 2 shows a part of the pulse superimposing unit 40 in the configuration of FIG. 1. That is, FIG. 2 shows one series circuit composed of a capacitor 18 and a driving amplifier 32 through a constant current source serving as a constant current driver. Actually, the similar series circuits are placed correspondingly to the three cameras 1 to 3 and the three transmission paths (cables) 44 in FIG. 1. By the way, naturally, the numbers of the transmission paths 44 and the series circuits are increased or decreased on the basis of the number of the cameras. The driving amplifier 32 composed of the plurality of constant current sources is connected to a single synchronous pulse generator 31, and the pulse generated by the synchronous pulse generator 31 is used as a trigger. Then, the driving amplifier 32 composed of the respective constant current sources carries out a constant current drive and generates an output signal. This output signal is sent to each of the respective transmission paths 44 through the capacitor 18 for stopping a direct current component. The connection to each of the transmission paths 44 is illustrated as a branch point 30 in FIG. 1. However, it can be defined as a branch point 60 that is configured so as to directly connect a signal line to the transmission path 44, as shown in FIG. 2.

Also, in the connection to the transmission paths 44 of the output signal lines from the pulse superimposing unit 40 to send the synchronous signal to the transmission paths 44 between the cameras 1 to 3 and the switcher 41, this is designed such that the branch points 60 serving as so-called branch connections cause the superimposition pulse signals to be easily coupled. Due to this design, as for the pulse generated by the synchronous pulse generator 31, the element in which the impedance on the side of the cameras 1 to 3 and the side of the switcher 41 is directly driven by the current is superimposed as a pulse voltage, by the driving circuit 32 operating as the constant current source.

As can be understood from the above-mentioned explanations, according to the present invention, a voltage division action is never induced differently from the case of the constant voltage source. Thus, the usage rate of the power supply is good, and the impedance is high. Even in the circuit configuration where the driving circuit has a bias, the direct current stopping capacitor 18 separates it from the transmission path of the camera. Thus, this is equivalent to the situation that nothing is connected.

The above-mentioned embodiment has been explained under the configuration that the pulse superimposing unit 40 is separated from the pulse superimposing unit 40. However, it can be configured such that the pulse superimposing unit 40 is included in any of the configuration units. Also, the embodiment has been explained by exemplifying the monitor TV camera system. However, the application range of the present invention is not limited thereto. It can be applied to all systems for switching and controlling the plurality of image signals and picture signals by using the synchronous signal from the external portion, such as a CCTV (Closed Circuit TV: a camera and a monitor are placed in a predetermined closed circuit, such as the monitor TV camera system and the like) system, CATV, a BS/CS system and the like.

As evident from the above-mentioned explanations, according to the present invention, by changing the synchronous signal superimposing method from the conventional method through the constant voltage source to the driving method through the constant current source, the generated synchronous signal can be superimposed on the image signal on the transmission path through the branch connection. Thus, this has the easy connection and the friendly property that it can be easily mixed even in the system such as the control data superimposition of the camera through the conventional constant voltage source or constant current source and the like. Thus, the present invention provides an excellent and advantageous effect that the configuration of the system can be simplified.

What is claimed is:

1. A synchronous signal superimposing apparatus, which, when switching between image signals generated by a plurality of image pickup units and selectively sending said image signal to at least one monitor, sends an external synchronous signal to each of a plurality of cables through which said image signal is transmitted from each of said image pickup units, and thereby superimposes said external synchronous signal on said image signal, further including:
a plurality of cables each transmitting said image signals from said plurality of image pickup units;
constant current drivers for responding to said external synchronous signal, in which the number of said constant current drivers is equal to the number of said plurality of cables; and
capacitors, each of which is inserted between each of output terminals of said constant current drivers and each of said plurality of cables, for stopping direct current components in output signals from said respective constant current drivers.

2. The synchronous signal superimposing apparatus according to claim 1, wherein said cable is matched and terminated in each of said image pickup units, and a switcher for selectively sending said image signal is further included, and devices, each of which matches and terminates said cable, are included in said switcher.

3. The synchronous signal superimposing apparatus according to claim 1, wherein said plurality of image pickup units are monitor cameras.

4. A synchronous signal superimposing method, which when switching between image signals generated by a plurality of image pickup units and selectively sending said image signal to at least one monitor, sends an external synchronous signal to each of a plurality of cables through which said image signal is transmitted from each of said image pickup units, and thereby superimposes said external synchronous signal on said image signal, further including the steps of:
generating a plurality of constant currents through a plurality of constant current drivers which respond to the external synchronous signal; and
stopping a direct current component included in each of said constant currents, sending to each of said plurality of cables, and then superimposing on said image signal.
